(19) United States
(12) Patent Application Publication
(10) Pub. No.: US 2026/0098983 A1
(43) Pub. Date: Apr. 9, 2026

(54) METHODS AND SYSTEMS FOR ARCHAEOLOGICAL INVESTIGATIONS AROUND AND UNDER PYRAMIDS

(71) Applicant: Maurice Nessim, Houston, TX (US)

(72) Inventors: Maurice Nessim, Houston, TX (US); Nicolae Moldoveanu, Nice (FR)

(21) Appl. No.: 19/378,686

(22) Filed: Nov. 4, 2025

Related U.S. Application Data
(63) Continuation-in-part of application No. 18/907,051, filed on Oct. 4, 2024, now Pat. No. 12,474,503.

(51) Int. Cl. G01V 11/00

(52) U.S. Cl. CPC G01V 11/002

(57) ABSTRACT

A method and system for non-invasive archaeological investigation of pyramid structures are disclosed. The method combines high-resolution three-dimensional seismic acquisition with Marchenko-based wavefield reconstruction and multiple-reflection imaging to detect and characterize subsurface features such as voids, tunnels, and hidden chambers beneath and around pyramids. Electromagnetic vibrators, generate compressional and shear waves without ground penetration, and three-component (3C) receiver nodes, optionally equipped with over-under muon detectors, record seismic and muon flux data simultaneously. The Marchenko method enables reconstruction of virtual internal sources and receivers, while multiple-reflection imaging provides information from deeper layers below the pyramid base. The invention offers a fully non-invasive, high-resolution, and reversible approach suitable for cultural heritage preservation.

### CROSS-REFERENCE TO RELATED APPLICATIONS

This application is a continuation-in-part of U.S. Ser. No. 18/907,051 filed Oct. 4, 2024 entitled Subsurface Exploration Instruments with Integrated Muon Detectors, which application is incorporated herein by reference.

This application is related to U.S. Pat. No. 11,467,304 entitled“High-Resolution Seismic Method and System for Detecting Underground Archeologic Structures”; U.S. application Ser. No. 18/907,051 filed Oct. 4, 2024 and PCT Application PCT/US25/49609 filed on Oct. 6, 2025 both of which are entitled “Subsurface Exploration Instruments with Integrated Muon Detectors”, all the aforementioned applications of which are incorporated herein by reference.

### FIELD OF THE DISCLOSURE

The present disclosure relates to non-invasive methods and systems for three-dimensional (3D) seismic and muon-based exploration around and beneath archaeological monuments and other large structures, such as pyramids. More specifically, the disclosure concerns the use of high-resolution 3D seismic acquisition combined with Marchenko-based wavefield reconstruction and multiple-reflection imaging to image, for example, subsurface features below the pyramid such as hidden artifacts and hidden chambers, optionally enhanced by muon flux measurements obtained from over-under muon detectors integrated within the seismic receiver nodes.

### BACKGROUND AND SUMMARY

Pyramids constructed by ancient civilizations stand as enduring evidence of human ingenuity, technical skill, and spiritual advancement. Egypt alone hosts more than one hundred and eighteen documented pyramids, each representing immense archaeological, cultural, and scientific significance. Traditional archaeological investigations typically rely on surface mapping, excavation, or limited geophysical methods such as electrical resistivity or ground-penetrating radar (GPR). These approaches are either invasive, limited in depth penetration, or insufficiently resolved to characterize deeper or complex subsurface structures-particularly those structures or features directly below the pyramid.

Recent advances in 3D seismic imaging provide a potential means for non-invasive subsurface investigation with improved resolution and depth penetration. However, conventional surface-only seismic acquisition suffers from limited short-offset coverage, reducing the ability to detect, for example, shallow, internal, or other features beneath monuments such as pyramids.

The present invention provides a method and system for non-invasive 3D seismic with optional muon-based imaging of pyramid structures and their surroundings. The method enables detection and characterization of, for example, hidden chambers, voids, tunnels, artifacts, and foundation structures while preserving the monument's integrity and without conventional invasive techniques such as excavation.

The system typically comprises a plurality of electromagnetic vibrators capable of generating both compressional (P) and shear(S) waves or wavefields, and 3C receiver nodes that can optionally include over-under muon detectors (patent pending). The deployment of sources and receivers typically fulfills sampling requirements which may vary. In some embodiments, suitable deployment of sources and receivers fulfills sampling requirement of Nyquist and/or compressive sampling and may provide a full azimuthal coverage or illumination of the subsurface including sediments around the and under the pyramid (or other suitable structure of interest). The data may be processed using Marchenko-based wavefield reconstruction and/or multiple-reflection imaging to synthesize virtual internal sources (i.e., simulated wave propagation from subsurface points). This may facilitate revealing subsurface features beneath the pyramid and/or surrounding features In some embodiments, the receivers may be deployed inside the pyramid and on the faces of the pyramid as shown in FIG. 4a.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1—An example of pyramid in Egypt (Saqqara Step Pyramid).

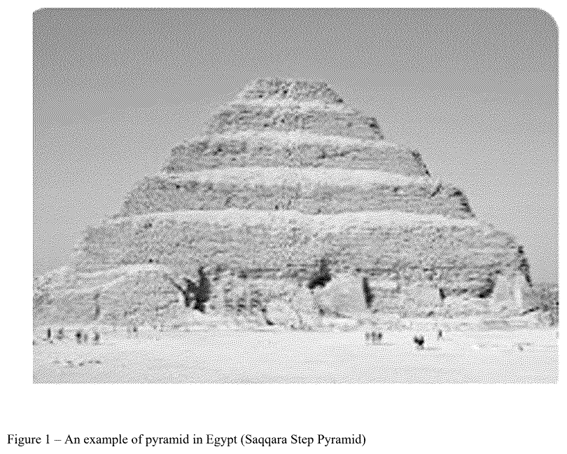

FIG. 2—Exemplary array of sources (red) and receivers (blue) deployed around the pyramid.

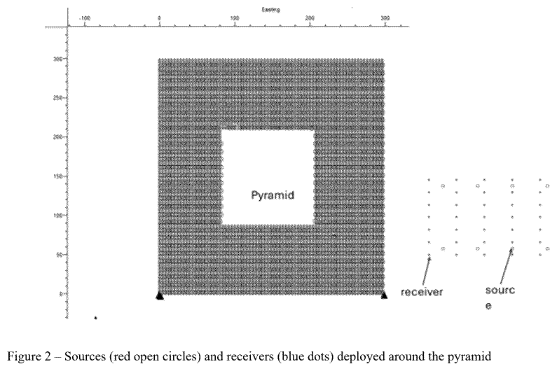

FIG. 3—An example of subsurface coverage of the offsets smaller than 25 m when sources and receivers are deployed around the pyramid; blank area shows that there may be no subsurface coverage for offsets smaller than 25 m in this embodiment.

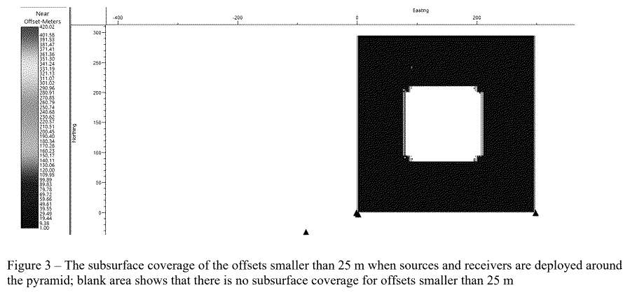

FIG. 4—Exemplary array of sources (red) and receivers (blue) deployed inside and around the pyramid.

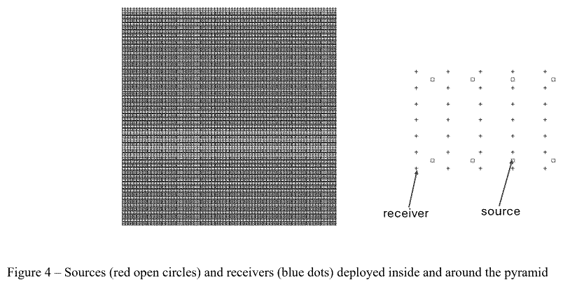

FIG. 4a—Exemplary array of receivers (blue dots) employed inside and on the faces of the pyramid.

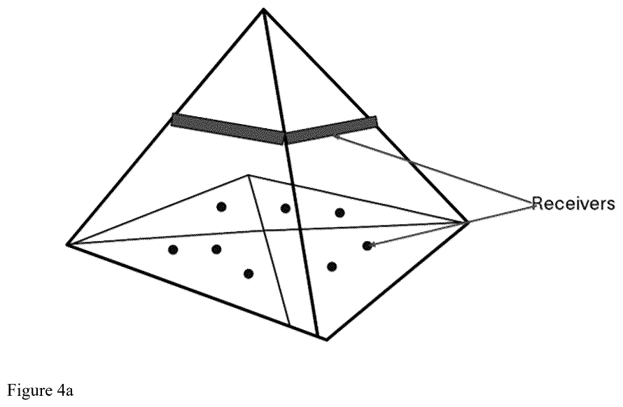

FIG. 5—Representative coverage fold for offsets smaller than 25 m for sources and receivers deployed in representative arrays inside and around the pyramid.

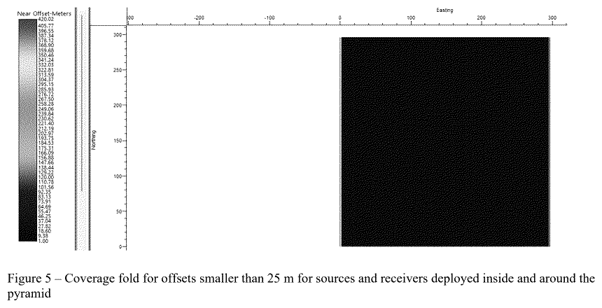

FIG. 6—First-order multiple reflection showing a representative manner of imaging under the pyramid.

### DETAILED DESCRIPTION OF THE INVENTION

### Seismic Acquisition Geometry

Arrays of electromagnetic surface vibrators may be positioned symmetrically around the pyramid to generate P- and S-wavefields. These sources typically require no ground penetration or heavy coupling, making them ideal for protected heritage environments or other large structures where invasive exploration techniques are unsuitable. The specific electromagnetic surface vibrators along with the specific array configuration employed are not particularly critical so long as generated waves or wavefields bounce, e.g., diffract or refract, from structures in a manner such that the bounced waves or wavefields may be received by a suitable receiver such as 3C nodes and the data processed as described herein. Thus, the specific electromagnetic surface vibrators and array may vary depending upon the size of the structure, e.g., pyramid, its shape, as well as the size, shape, area, and/or depth of the region of exploration interest.

Receivers are deployed around and, optionally, inside the pyramid using autonomous three-component (3C) nodes. In a preferred embodiment, the receivers are 3C nodes integrated with over-under muon detectors that measure muon flux from above and below. Useful representative nodes with over-under muon detectors are described in, for example, U.S. application Ser. No. 18/907,051 filed Oct. 4, 2024 and PCT Application PCT/US25/49609 filed on Oct. 6, 2025, both of which are entitled “Subsurface Exploration Instruments with Integrated Muon Detectors” and both of which are incorporated herein by reference. This hybrid acquisition provides simultaneous sensitivity to seismic and density variations which often results in better imaging.

The specific array and deployment of the receivers may vary depending upon the size of the structure, e.g., pyramid, its shape, as well as the size, shape, area, and/or depth of the region of exploration interest. In some embodiments, suitable deployment of sources and/or receivers fulfills sampling requirement of Nyquist and/or compressive sampling and may provide a full azimuthal coverage or illumination of the subsurface including sediments around the and under the pyramid (or other suitable structure of interest).

### Marchenko-based and Multiple-reflection Wavefield Reconstruction

Seismic reflection data acquired from the described configurations may be processed using any useful technique that achieves the ultimate desired imaging. In some embodiments, useful techniques involve obtaining virtual sources, virtual receivers or both. Such virtual sources and/or receivers may advantageously be derived such that either or both are inside the structure, e.g., pyramid of interest. In this manner, the virtual sources and/or receivers may improve imaging and/or its interpretation by simulating wave propagation from subsurface points. That is, simulated waves may be propagated and/or received from beneath the structure without invasively putting physical sources and/or receivers beneath the structure. This is particularly advantageous for archeological structures like pyramids wherein much of the area of interest containing, for example, artifacts is below the pyramid. The virtual sources and/or receivers may then be used to facilitate seismic techniques like wavefield reconstruction and/or multiple-reflection imaging techniques to image below and/or around the pyramid or other structure.

A representative technique for useful technique for obtaining virtual sources, virtual receivers or both includes, for example, Marchenko-based wavefield reconstruction and/or multiple-reflection imaging techniques. The Marchenko method advantageously may retrieve both upgoing and downgoing Green's functions between surface and subsurface points. This may allow for the synthesis of the desired virtual sources and receivers inside the pyramid or even elsewhere such as beneath or around the pyramid or structure in some embodiments. In some embodiments, techniques for obtaining virtual receivers and/or virtual sources may be employed that are described in the following reference which is incorporated by reference: Satyan Singh, Cornelis Wapenaar, Joost Van Der Neut, and Roelof Snieder, (2016), “Beyond Marchenko: Obtaining virtual receivers and virtual sources in the subsurface,” SEG Technical Program Expanded Abstracts: 5166-5171.

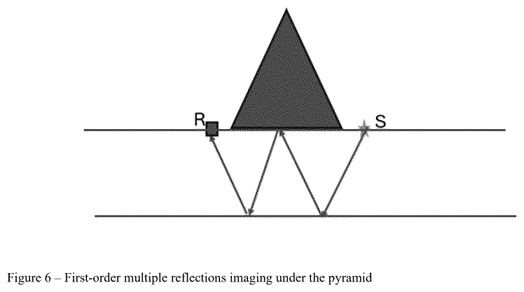

If desired, higher-order multiple reflections techniques may be used alone or with Marchenko-based wavefield reconstruction. While higher-order multiple reflections techniques are not limited to subsurface information, they may be particularly preferable for such information. As illustrated in FIG. 6, first-order and higher-order multiple reflections can be used to obtain subsurface information beneath the pyramid's base. These multiples often contain additional wavefield components that carry information about deeper layers and/or hidden features that are not usually visible using other techniques. Advantageously, Marchenko demultiple and imaging algorithms, data-driven multiple reflection migration, or the combination thereof can reconstruct reflectors located beneath the pyramid foundation.

### Representative Advantages

The proposed methods may offer several key advantages (among others) when exploring structuring such as pyramids: fully non-invasive operation, high-resolution imaging, hybrid seismic-muon sensing and/or processing, safe deployment, and/or significant scientific value for cultural heritage preservation.

### EMBODIMENTS

1. A method for non-invasive three-dimensional seismic investigation around and beneath a pyramid, wherein the method comprises:
employing a plurality of electromagnetic vibrators around the pyramid to generate P and S wavefields;
employing a plurality of 3C receiver nodes around the pyramid to receive P and S wavefields;
acquiring seismic data from the received P and S wavefields; and
processing the seismic data using Marchenko-based wavefield reconstruction to obtain virtual sources within or below the pyramid.

2. The method of embodiment 1, wherein the method further comprises employing one or more 3C receiver nodes inside the pyramid.

3. The method of embodiment 1, wherein the electromagnetic vibrators are configured to transmit ground motion via electromagnetic actuation.

4. The method of embodiment 1, which further comprises employing one or more 3C receiver land nodes equipped with over-under muon detectors, wherein the one or more 3C receiver land nodes are configured for concurrent muon and seismic data acquisition.

5. The method of embodiment 4, further comprising integrating the concurrently acquired muon and seismic data to estimate density and elastic property variations below the surface of the pyramid.

6. The method of embodiment 1, wherein the Marchenko-based wavefield reconstruction comprises reconstructing upgoing and downgoing Green's functions to generate the virtual sources.

7. The method of embodiment 1, which further comprises revealing subsurface anomalies, voids, or chambers beneath the pyramid foundation using imaging.

8. The method of embodiment 1, further comprising processing first-order and higher-order multiple reflections to reconstruct subsurface features located beneath the pyramid.

9. The method of embodiment 2, further comprising processing first-order and higher-order multiple reflections to reconstruct subsurface features located beneath the pyramid.

10. The method of embodiment 4, further comprising processing first-order and higher-order multiple reflections to reconstruct subsurface features located beneath the pyramid.

11. The method of embodiment 8, which further comprises employing multiple-reflection imaging using Marchenko-based demultiple and imaging algorithms

12. The method of embodiment 8, which further comprises employing multiple-reflection imaging using data-driven multiple reflection migration.

13. A system comprising:
a plurality of electromagnetic vibrators for generating P and S wavefields surrounding a structure to be imaged;
a plurality of 3C receiver nodes surrounding the structure to be imaged; and
a processor configured to receive seismic data from the received P and S wavefields and process the received data employing Marchenko reconstruction and 3D imaging.

14. The system of embodiment 13 further comprising muon detectors integrated with the plurality of 3C receiver nodes, wherein the plurality of 3C receiver land nodes with integrated muon detectors are configured for concurrent muon and seismic data acquisition.

14. The system of embodiment 13, wherein the plurality of electromagnetic vibrators and the plurality of 3C receivers are portable.

15. The system of embodiment 14, wherein the integrated muon detectors are configured to enhance density imaging by differentiating between a downward and an upward muon flux.

16. The system of embodiment 13, wherein the processor is configured to improve subsurface resolution by performing joint inversion of seismic and muon data.

1. A method for non-invasive three-dimensional seismic investigation around and beneath a pyramid, wherein the method comprises:
employing a plurality of electromagnetic vibrators around the pyramid to generate P and S wavefields;
employing a plurality of 3C receiver nodes around the pyramid to receive P and S wavefields;
acquiring seismic data from the received P and S wavefields; and
processing the seismic data using Marchenko-based wavefield reconstruction to obtain virtual sources within or below the pyramid.

2. The method of claim 1, wherein the method further comprises employing one or more 3C receiver nodes inside the pyramid.

3. The method of claim 1, wherein the electromagnetic vibrators are configured to transmit ground motion via electromagnetic actuation.

4. The method of claim 1, which further comprises employing one or more 3C receiver land nodes equipped with over-under muon detectors, wherein the one or more 3C receiver land nodes are configured for concurrent muon and seismic data acquisition.

5. The method of claim 4, further comprising integrating the concurrently acquired muon and seismic data to estimate density and elastic property variations below the surface of the pyramid.

6. The method of claim 1, wherein the Marchenko-based wavefield reconstruction comprises reconstructing upgoing and downgoing Green's functions to generate the virtual sources.

7. The method of claim 1, which further comprises revealing subsurface anomalies, voids, or chambers beneath the pyramid foundation using imaging.

8. The method of claim 1, further comprising processing first-order and higher-order multiple reflections to reconstruct subsurface features located beneath the pyramid.

9. The method of claim 2, further comprising processing first-order and higher-order multiple reflections to reconstruct subsurface features located beneath the pyramid.

10. The method of claim 4, further comprising processing first-order and higher-order multiple reflections to reconstruct subsurface features located beneath the pyramid.

11. The method of claim 8, which further comprises employing multiple-reflection imaging using Marchenko-based demultiple and imaging algorithms.

12. The method of claim 8, which further comprises employing multiple-reflection imaging using data-driven multiple reflection migration.

13. A system comprising:
a plurality of electromagnetic vibrators for generating P and S wavefields surrounding a structure to be imaged;
a plurality of 3C receiver nodes surrounding the structure to be imaged; and
a processor configured to receive seismic data from the received P and S wavefields and process the received data employing Marchenko reconstruction and 3D imaging.

14. The system of claim 13 further comprising muon detectors integrated with the plurality of 3C receiver nodes, wherein the plurality of 3C receiver land nodes with integrated muon detectors are configured for concurrent muon and seismic data acquisition.

15. The system of claim 13, wherein the plurality of electromagnetic vibrators and the plurality of 3C receivers are portable.

16. The system of claim 14, wherein the integrated muon detectors are configured to enhance density imaging by differentiating between a downward and an upward muon flux.

17. The system of claim 13, wherein the processor is configured to improve subsurface resolution by performing joint inversion of seismic and muon data.
